(19) United States
(12) Patent Application Publication
(10) Pub. No.: US 2008/0301713 A1
(43) Pub. Date: Dec. 4, 2008

(54) Systems and methods for electronic evidence management with service control points and agents

(76) Inventors: Marc Demarest, Forest Grove, OR (US); Santosh Lolayekar, Cupertino, CA (US); Kenneth Krutsch, Minnetonka, MN (US); Karl Schubert, Minnetonka, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/809,542

(22) Filed: May 31, 2007

(51) Int. Cl. G06F 3/00

(52) U.S. Cl. 719/317

(57) ABSTRACT

Systems and methods are provided for capturing electronic evidence using one or more agents and at least one service control point. The systems and methods comprise deploying the one or more agents to one or more sources of electronic evidence. One or more events are transmitted from the at least one service control point to the one or more agents, wherein the one or more agents do not perform any tasks unless events are received. Upon receipt of the one or more events by the one or more agents, at least one task is performed on the one or more sources of electronic evidence.

### FIELD

The present disclosure generally relates to electronic evidence management and, in particular, relates to systems and methods for electronic evidence management with service control points and agents.

### BACKGROUND

Information is growing at staggering rates, in a manner that is regulated, legislated, litigated, and depended on as never before. This situation presents significant information risk management (IRM) issues for organizations in many different areas. One area is litigation and investigation, where there is a need to comply with litigation requirements or support internal investigations. Another area is regulatory compliance, where there is a need for handling all information and records in accordance with applicable laws and regulations. Yet another area is information governance, where there is a need to protect critical confidential information and trade secrets. In another area, business continuity, there is a need for assurance that data is manageable, accessible, and in the case of unforeseen disasters, recoverable. Presently available systems only offer point solutions that address risks for typically one of the above categories to solve specific issues. Such prior art systems do not typically address risks for more than one area, and often exacerbate problems for other areas. Furthermore, such systems have static, non-extensible frameworks for capturing and organizing information that limits an organization's ability to manage risk or investigate incidents where organization or regulatory policy is violated.

Organizations typically have rules or policies for information management, but do not have methods to consistently apply the rules or policies to all electronic information in an organization's network. Organizations are typically subject to a myriad of information-related rules, regulations, and compliance regimes and laws. These information management regimes change over time. Often, a single electronic record is associated with multiple compliance regimes. Compliance regimes can potentially be in conflict with one another. Most organizations strive to destroy electronic information not subject to regulatory retention schedules as soon as practicable. However, it is difficult to destroy electronic information, since there are frequently multiple copies of the information existing throughout an organization. Also, the electronic information that has been deleted can frequently be recovered by forensic computer processes.

For many organizations, recorded information management schedules are often challenging to implement and process, as is complying with a legal hold order. It is often difficult for the organization follow the trail of who has sent, received, or viewed the electronic information, and where it has been stored. Furthermore, sequestering or restricting electronic access to electronic information is challenging, as information often resides on multiple nodes in an organization's computer network.

A violation of a policy of an organization can be considered an incident. Depending on the nature of the incident, the violation of organizational policy can ultimately lead to a lawsuit or regulatory agency investigation. Every piece of information that exists in the company (not just paper) the moment an incident occurs is potential evidence. Organizations that do not address paper and electronic information when it is created have difficulty in complying with a legal obligation to preserve the information, being able to guarantee the integrity of the information, being able to produce the information when subpoenaed, and not knowing what opposing counsel will find when they review the information.

### SUMMARY

Exemplary embodiments provide novel systems and methods for integrated information risk management (IRM). More specifically, these exemplary embodiments provide capture of potential electronic evidence, organization and storage of the electronic evidence, and enforcement of organization and regulatory policy (e.g., retention policies, behavior policies, conduct policies, etc.).

Exemplary embodiments as described herein capture electronic evidence within an organization without the need for individual users to explicitly publish the evidence to an evidence management system. Captured electronic evidence may include, but is not limited to, electronic documents, email, scanned documents, reports, messages, voice over internet protocol (VOIP), logs, any combination thereof, or any other suitable information. Systems and methods of the exemplary embodiments described herein identify, decompose, analyze, interpret, classify, index, and apply policies (e.g., organization specific retention and behavior policies, regulatory policies, behavior policies, etc.). The captured electronic evidence and associated extensible metadata may be stored in a secure digital storage repository.

An exemplary embodiment relates to a method capturing electronic evidence using one or more agents and at least one service control point. One or more agents are deployed to one or more sources of electronic evidence. One or more events are transmitted from the at least one service control point to the one or more agents, wherein the one or more agents do not perform any tasks unless events are received. Upon receipt of the one or more events by the one or more agents, at least one task is performed on the one or more sources of electronic evidence.

Another exemplary embodiment relates to a system for capturing electronic evidence using one or more agents and at least one service control point. The system comprises means for deploying the one or more agents to one or more sources of electronic evidence. The system further comprises means for transmitting one or more events from the at least one service control point to the one or more agents, wherein the one or more agents do not perform any tasks unless events are received. Upon receipt of the one or more events by the one or more agents, the system further comprises means for performing at least one task on the one or more sources of electronic evidence.

Yet another exemplary embodiment relates to a computer readable medium comprising software that, when executed by a computer, causes an electronic evidence management system to perform a method capturing electronic evidence using one or more agents and at least one service control point. One or more agents are deployed to one or more sources of electronic evidence. One or more events are transmitted from the at least one service control point to the one or more agents, wherein the one or more agents do not perform any tasks unless events are received. Upon receipt of the one or more events by the one or more agents, at least one task is performed on the one or more sources of electronic evidence.

Additional features will be set forth in the description below, and in part will be apparent from the description, or may be learned by practice of the exemplary embodiments. The exemplary embodiments will be realized and attained by the structure particularly pointed out in the written description and claims hereof as well as the appended drawings.

It is to be understood that both the foregoing general description and the following detailed description are exemplary and explanatory and are intended to provide further explanation of the claims.

### BRIEF DESCRIPTION OF THE DRAWINGS

The accompanying drawings, which are included to provide further understanding of the exemplary embodiments and are incorporated in and constitute a part of this specification, illustrate embodiments and together with the description serve to explain the embodiments. In the drawings:

FIG. 1 is a block diagram an evidence management system according to an exemplary embodiment;

FIG. 2 is a block diagram of the capture system of the evidence management system according to an exemplary embodiment;

FIG. 3A is a block diagram of the evidence management system agents communicatively coupled to a Service Control Point (SCP) according to an exemplary embodiment;

FIG. 3B is a more detailed block diagram of an evidence management system agent of FIG. 3A according to an exemplary embodiment;

FIG. 4 illustrates an Intelligent Object Analyzer (IOA) of the evidence management system according to an exemplary embodiment; and

FIG. 5 illustrates a centralized event system of the evidence management system according to an exemplary embodiment.

### DETAILED DESCRIPTION

In the following detailed description, numerous specific details are set forth to provide a full understanding of the exemplary embodiments. It will be obvious, however, to one ordinarily skilled in the art that the embodiments may be practiced without some of these specific details. In other instances, well-known structures and techniques have not been shown in detail so as not to obscure the embodiments.

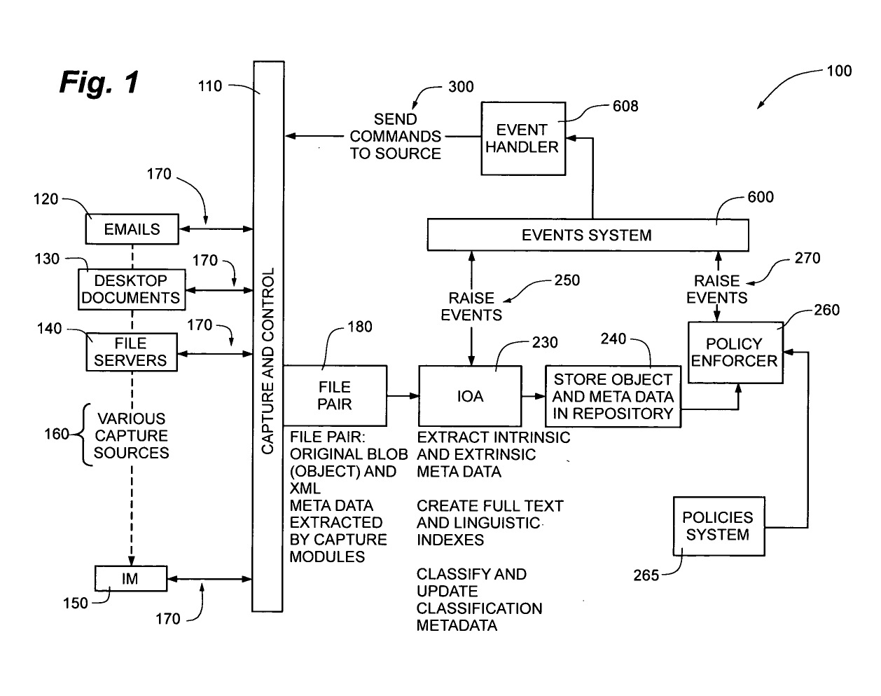

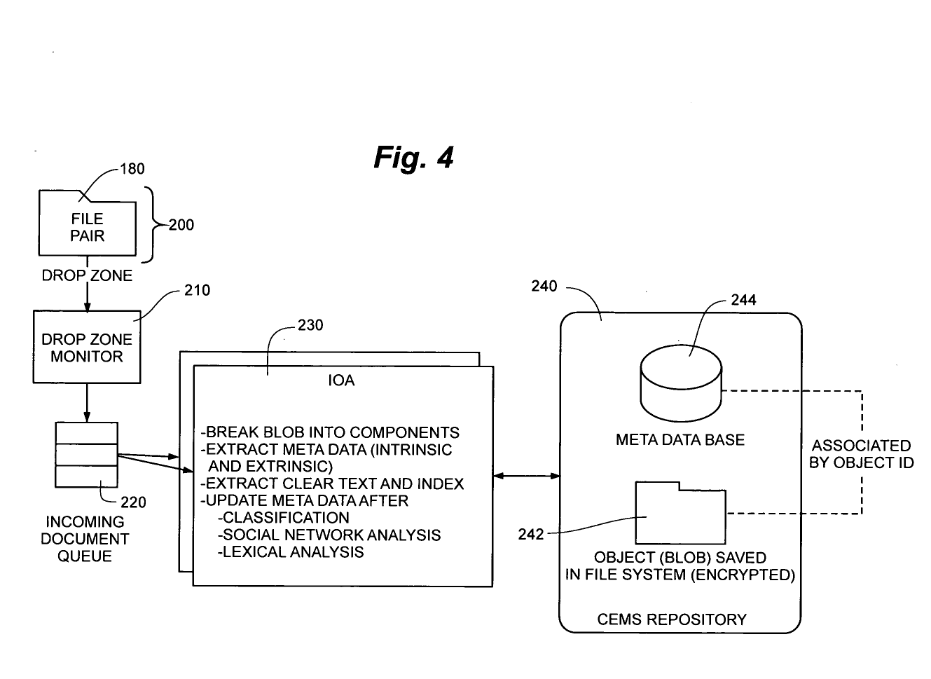

Corporate Evidence Management System (“CEMS”) captures electronic evidence of an organization and stores it in a CEMS repository for searching, analyzing, and managing policies and production. CEMS may be configured on one or more computers, servers, or other computing devices, and may be communicatively coupled with a communications network and one or more digital storage devices. CEMS system 100 illustrated in FIG. 1 captures evidence data with capture and control system 110 from various sources (e.g., email source 120, desktop document source 130, file server source 140, instant messaging source (IM) 150, or other capture sources 160, etc.) communicatively coupled to communications network 170. Other capture sources 160 may be comprised of VOIP (Voice Over Internet Protocol) systems, log files of network activity, electronic archives, backup electronic data storage, backfires, document repositories (e.g., portals, document management systems, intranets, etc.), or any other suitable sources. Capture and control system 110 provides a common interface to connect to various capture sources (e.g., email source 120, desktop document source 130, file server source 140, instant messaging source (IM) 150, or other capture sources 160, etc.) which communicatively couple to capture and control system 110, and which may be a separate system from CEMS system 100. Capture and control system 110 interfaces with CEMS system 100 by placing the captured electronic evidence from sources 120, 130, 140, 150 or 160 in a secure location within CEMS system 100 (e.g., CEMS repository 240 shown in FIGS. 1 and 4). Capture and control system 110 may use a globally unique identifier (“GUID”) to name the captured evidence. Alternatively, paper and other physical media may be scanned or otherwise converted to electronic form for capture (e.g, by bulk capture interface 426 or file capture interface 428 of capture system 400 shown in FIG. 4). The secure storage location (e.g., CEMS repository 240) of CEMS system 100 may be one or more of any suitable digital data storage devices.

The electronic evidence captured by capture system 110 may be comprised of at least two components. These components of the captured electronic evidence comprise a “file pair,” for example, file pair 180 as illustrated in FIG. 1. File pair 180 may be comprised of an object (i.e., binary large object, or “blob”) which is the originally captured electronic evidence and the blob's associated metadata (e.g., extensible markup language (XML) metadata). Alternatively, when paper evidence is captured (e.g., scanned to form electronic data, etc.) or when other media evidence is captured, the evidence may be a file triplet having the original image file, the associated optical character recognition (OCR) text file, and the metadata.

After capture, file pair 180 is placed in a CEMS drop zone (e.g., drop zone 200 illustrated in FIG. 4), which may comprise at least one digital data storage device. Once located in CEMS drop zone 200, file pair 180 may be stored by CEMS system 100 in CEMS repository 240 (also illustrated in FIG. 4). CEMS repository 240 may be one or more of any suitable digital data storage devices and may preferably have data security measures to secure the stored information (e.g., encryption, limited file access, or any combination thereof, etc.). A CEMS event (e.g., event 250) is raised for CEMS Intelligent Object Analyzer (IOA) 230 (also illustrated in FIG. 4) to further process file pair 180. IOA 230 decomposes the object into its components (e.g., separating attachment files from email, etc.), if any, and extracts the intrinsic and extrinsic metadata of the object. In other words, file pair 180 is separated into an object component and metadata. The separated object is stored in object file system 242, and its associated metadata is stored in CEMS metadata database 244 (both illustrated in FIG. 4). Object file system 242 and metadata database 244 preferably may be components of CEMS secure repository 240. IOA 230 may extract the text from the object stored in object file system 242 (by removing all the formatting information contained in the document) and use a full-text index engine to index the object based on the extracted text. IOA 230 classifies the object based on its content (e.g., indexed extracted text) and updates associated classification metadata (e.g., metadata associated with the object and stored in metadata database 244 of CEMS repository 240). In CEMS system 100, an object can concurrently belong to multiple classifications (i.e., an object stored in object file system 242 may have one or more associated links with one or more metadata tags stored in metadata database 244).

CEMS system 100 may be configured to have scalable metadata such that an object has multiple classifications (e.g., metadata classification tags) and is not restricted by initial classification categories (e.g., the categories configured upon installation of CEMS or initially defined by an administrator). For example, an object stored in object file system 242 (show in FIG. 4) may have metadata and classification tags associated with them initially after being stored in CEMS repository 240 (e.g., intrinsic and extrinsic metadata, as described herein, classification tags, etc.). New classification tags or metadata tags may be created and subsequently stored in metadata database 244 (shown in FIG. 4), and associated with an object. Once an object is stored in CEMS secure repository 240, policies (e.g., policies system 265, which may include organizational policies, regulatory policies, retention policies, behavior policies, or other related policies that are defined and stored in a digital data storage system) associated with the object are activated and enforced (e.g., by policy enforcer 260). New policies may be added to policies system 265 at any time, and enforced by policy enforcer 260. Policy conflicts are managed by system rules, and policies system 265 may store the rules regarding policy conflicts as well as resolve policy conflicts prior to policy enforcer 260 enforcing the policies. Alternatively, policies system 265 and policy enforcer 260 may collaboratively resolve policy conflicts.

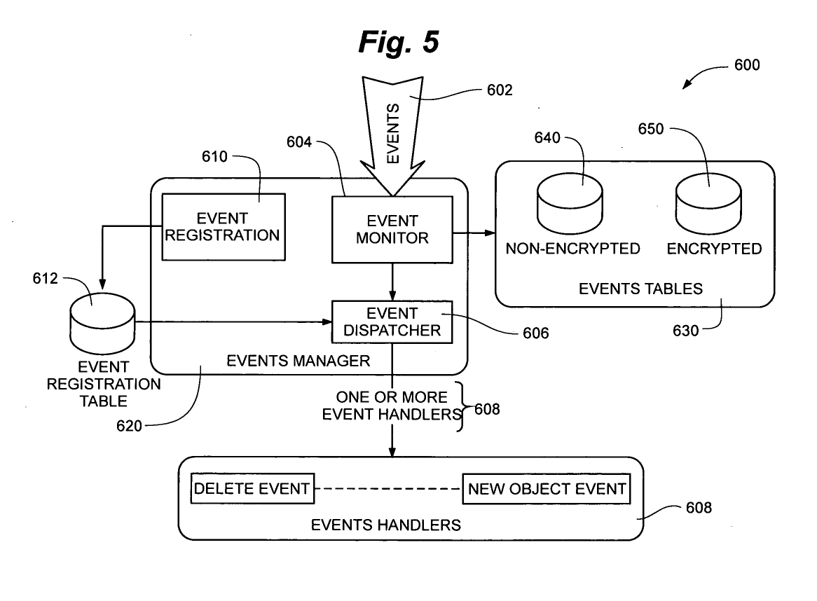

In one exemplary embodiment, CEMS system 100 has a centralized events system (e.g., events system 600 shown in FIGS. 1 and 5) which is configured to have a registration system (e.g., events registration 610 and events registration table 612 shown in FIG. 5) to dispatch events (e.g., events 250 or 270 shown in FIG. 1, or events 602 illustrated in FIG. 5) to events handler 608 (shown in FIG. 5), and optionally, as defined by policies (e.g., policies defined in policies system 265), sends commands 300 to a source (e.g., sources 120, 130, 140, 150, 160, etc.) via capture and control system 110. Events system 600 is described in detail below in connection with FIG. 5. Components of CEMS system 100 may raise an event (e.g., even 250 raised by IOA 230, event 270 raised by policy enforcer 260, events 602 shown in FIG. 5, etc.) which is interpreted by events manager 620 of events system 600 and is dispatched by central events monitor 604. In response to the raised event, CEMS system 100 may take predetermined actions (e.g., enforce a retention policy, etc.). Events system 600 may be configured to evaluate raised events. Some raised events in CEMS system 100 may send commands 300 to a source via capture system 110, for example, to “destroy a file” at a capture source (e.g., source 120, 130, 140, 150, or 160). In this example, the event may be received by capture and control system 110, which is configured to interpret the event and, in turn, send a command to the appropriate source (e.g., source 120, 130, 140, 150, or 160) which is communicatively coupled to capture and control system 110 via communications network 170.

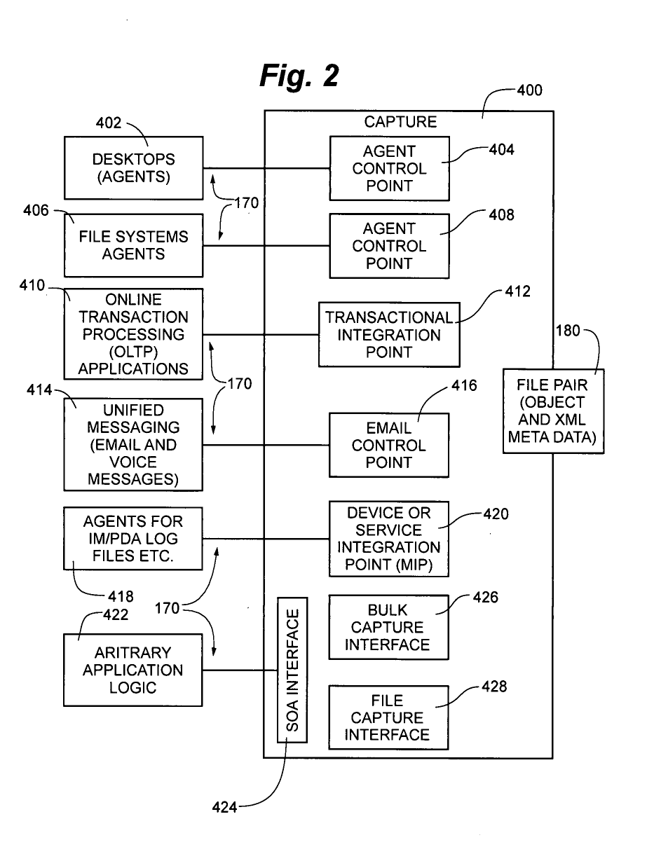

CEMS system 100 illustrated in FIG. 1 captures electronic evidence data within an organization without the need for individual users to publish the evidence to a electronic data management system. As illustrated in further detail in FIG. 2, CEMS system 100 captures evidence from variety of sources.

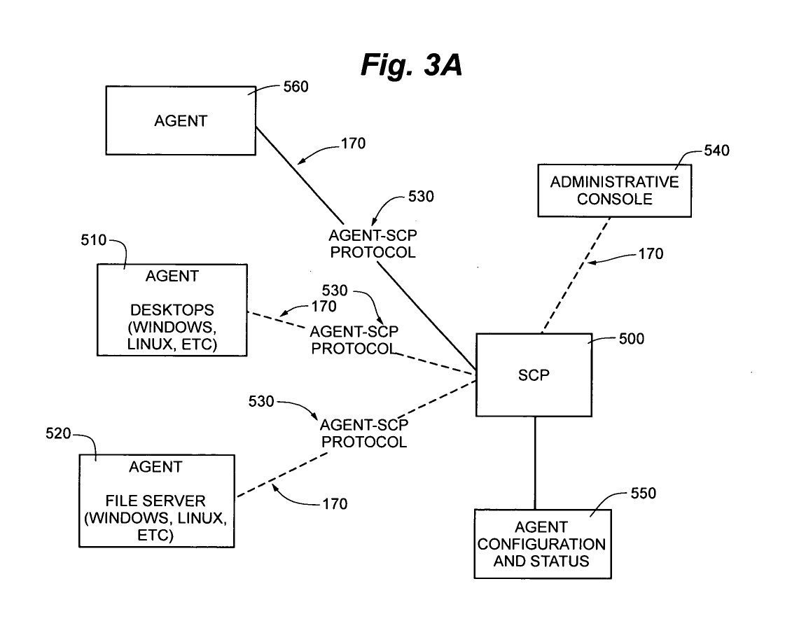

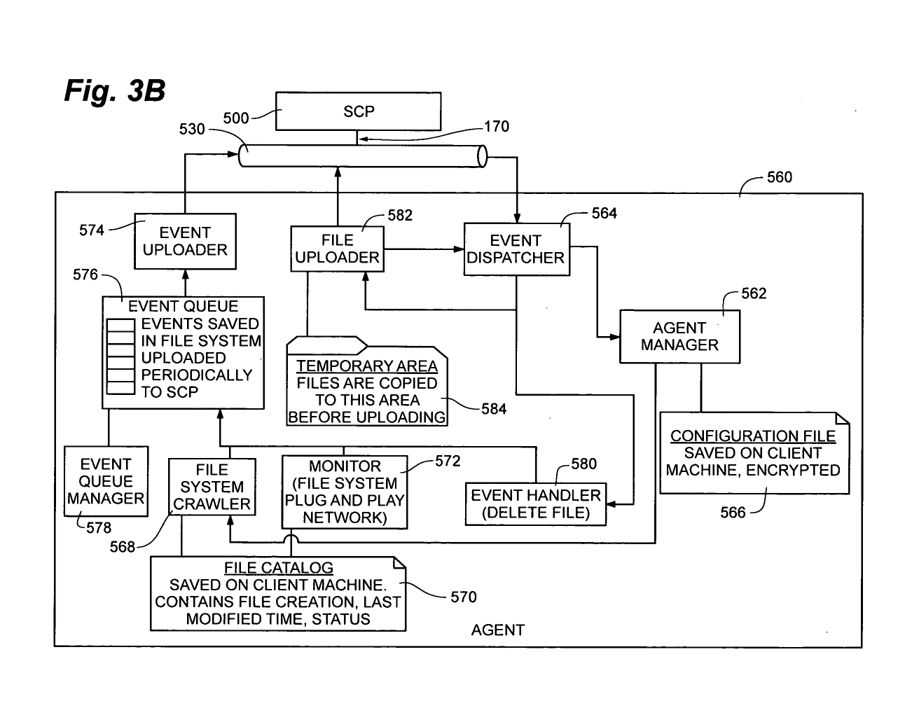

CEMS agents (e.g., agents 510, 520, or 560 illustrated in FIG. 3A, or similar agents) are deployed on client machines (e.g., desktop systems 402, file systems 406, etc.) and are managed by a central service control point (SCP) 500 (illustrated in FIGS. 3A and 3B). Service control point 500 and capture system 400 (illustrated in FIG. 2) may be components of capture and control system 110 of FIG. 1. CEMS system 100 may have one or more SCPs, each of which are communicatively coupled with one or more agents via a communications network. One or more agents reside on the systems (e.g., desktop systems 402, file systems 404, etc.) that CEMS system 100 monitors.

As illustrated in FIG. 2, agents may be deployed on desktop systems 402 to collect electronic evidence and perform other activities as instructed by agent control 404 of capture system 400. Desktop systems 402 may be a desktop computer, laptop computer, or any other computing device. Agent control 404, which is preferably a component of capture system 400 and communicatively coupled via communications network 170 with desktop systems 402, may deploy agents (e.g., agent 510 of FIGS. 3A and 3B) on desktop systems 402 configured to collect electronic evidence, monitor the activities of desktop systems 402, enforce organizational policy, place holds on electronic evidence, or any other suitable task, or any combination thereof. Agents deployed and controlled by agent control 404 may preferably gather and provide electronic evidence from or perform other suitable tasks on desktop system 402 when instructed to by agent control 404.

Agents may also be deployed on file systems 406 to collect electronic evidence and perform other activities as instructed by agent control 408 of capture system 400. File systems 406 may be one or more digital storage devices for storing data of at least a portion of an organization, or any other suitable file system of a computing device. Agent control 408, which is preferably a component of capture system 400 and communicatively coupled via communications network 170 with file systems 406, may deploy agents (e.g., agents 520 illustrated in FIG. 3A) on file systems 406 configured to collect electronic evidence, monitor the activities of these file systems, enforce organizational policy, place holds on electronic evidence, or any other suitable task, or any combination thereof. Agents deployed and controlled by agent control 408 may preferably gather and provide electronic evidence from or perform other suitable tasks on file systems 406 when instructed to by agent control 408. These tasks may be carried out in response to enforcement of organization policy (e.g., organization policies defined in policies system 265 and enforced by policy enforcer 260 of FIG. 1).

CEMS capture system 400 may be configured to collect information from and perform other activities on an organization's on-line transaction processing (OLTP) applications 410 through a common transaction integration point 412. OLTP applications 410 may be, for example, electronic commerce applications, or any other suitable applications. OLTP applications 410 may, for example, run on a server, a personal computer, a laptop computer, a processor, or any suitable computing device. Transactional integration point 412, which is preferably a component of capture system 400 and communicatively coupled via communications network 170 with OLTP applications 410, may deploy agents (e.g., agents similar to agents 510 or 520 illustrated in FIGS. 3A and 3B) on the server or other computing device running OLTP applications 410 and may be configured to collect electronic evidence, monitor the transactional activities of these applications, enforce organizational policy, place holds on electronic evidence, or any other suitable task. These tasks may be carried out in response to enforcement of organization policy (e.g., organizational policies, retention policies, or other policies defined in policies system 265 and enforced by policy enforcer 260 of FIG. 1). Agents deployed and controlled by agent control 408 may preferably gather and provide electronic evidence from OLTP applications 410 when instructed to by transactional integration point 412. Alternatively, OLTP applications 410 may be configured to send periodic reports as emails to CEMS system 100 using the email control 416.

CEMS capture system 400 may be configured to capture electronic messages and voice messages. Email control point 412, which is preferably a component of capture system 400 and communicatively coupled via communications network 170 with unified messaging system 414, may deploy agents (e.g., agents similar to agents 510 or 520 illustrated in FIGS. 3A and 3B) on unified messaging systems 414 configured to collect electronic evidence or voice messages, monitor the voice or electronic mail traffic, enforce organizational policy, place holds on electronic evidence, or any other suitable task, or any combination thereof. Unified messaging systems 414 may be comprised of email systems, voice messaging systems, or any suitable combination thereof. Unified messaging systems 414 provide a common interface to communicate with and instruct agents (e.g., similar to agents 510 and 520 of FIGS. 3A and 3B) to perform collection or other activities on one or more email, servers configured with Microsoft® Exchange, Lotus® Domino or Novell® Groupwise, or other suitable email server applications, or on voice messaging systems. At least one unified messaging system may be configured to send one or more emails to CEMS system 100 and may require agents to manage retention and retrieval of emails in the unified messaging system. Further, these unified messaging systems may allow for remote connection, in which case these agents may run or be deployed on CEMS system 100. In other words, agents may be deployed on client systems, where they may capture electronic evidence or enforce policies, or they may run on CEMS system 100 (e.g., one or more server systems or other computing devices) where the agents connect to the unified messaging system to capture electronic evidence, enforce policies, or any other suitable task.

Email control point 412 may be configured such that CEMS capture system 400 captures emails, voicemails, or any combination thereof. Email Control Point 416 performs actions on the email servers or voice messaging systems of united messaging systems 414 which are directed by CEMS policies (e.g., organizational policies defined in policies system 265 and enforced by policy enforcer 260 of FIG. 1) or users. Actions may include, but are not limited to, destruction of emails after a retention period has expired, or sending back emails from CEMS system 100 to an email server of unified messaging system 414 for recovery of lost or archived items, or other suitable actions.

CEMS capture system 400 may be configured to capture of information (e.g., messages, log files, documents, etc.) from other devices, such as personal digital assistants (PDAs), cellular phones, portable email devices (e.g., BlackBerry® devices, etc.) and other services, such as Instant Messages (IMs). As shown in FIG. 2, IM/PDA systems 418 may be comprised of these devices and service. IM/PDA systems 418 may be communicatively coupled via communications network 170 to CEMS capture system 400. CEMS capture system 400 may also be configured to capture of log files that are generated by numerous and various devices in the organization's network, represented by IM/PDA systems 418. Device or service integration point 420, which is preferably a component of capture system 400 and communicatively coupled via communications network 170 with IM/PDA systems 418, may deploy agents on IM/PDA systems 418 in order to collect electronic evidence or log files, monitor IM or network traffic, enforce organizational policy, place holds on electronic evidence, or any other suitable task. Device or service integration point 420 performs actions on IM/PDA systems 418 which are directed by CEMS policies (e.g., organizational policies defined in policies system 265 and enforced by policy enforcer 260 of FIG. 1) or users.

CEMS system 100 may be configured such that users may publish documents (i.e., deliver evidence) to CEMS system 100 through Service Oriented Architecture (SOA) interface 424 of CEMS capture system 400. SOA interface 424 may also be configured for interfacing (e.g., over communications network 170) with other document management systems (e.g., application systems 422, Microsoft® Sharepoint, etc.) for automatically publishing documents into CEMS system 100 or for bulk capture of documents from media (e.g., compact discs, DVDs, etc.). Preferably, SOA interface 424 may be configured to capture potential evidence from alternative sources, where such potential evidence may not be captured from, for example, sources such as desktop systems 402, file systems 406, OLTP applications 410, unified messaging systems 414, or IM/PDA systems 418. SOA interface 424 provides CEMS system 100 with bulk capture interface 426 configured to capture electronic evidence from sources of media (e.g., compact discs, DVDs, etc.) and file capture interface 428 which may capture electronic evidence from other document management systems (e.g., applications 422).

FIG. 3A illustrates communications between remotely deployed agents (e.g., agents 510, 520, 560, etc.) and the SCP (e.g., SCP 500) with an agent-SCP protocol (e.g., agent-SCP protocol 530). Agent 510 which may be deployed, for example, on desktop computers, laptop computers, or other computing devices in an organization's network may communicate over communications network 170 with SCP 500 using agent-SCP protocol 530. For example, agent 510, may be deployed on desktop systems 402 of FIG. 2. Similarly, agent 520 may be deployed on file servers or file systems communicatively coupled to an organization's network. For example, agent 520 may be deployed on file systems 406 of FIG. 2. CEMS agents are installed on systems that have been identified for monitoring. Agents (e.g., agents 510, 520, 560, etc.) may be deployed for various activities on remote client systems. For example, agents may crawl file systems, monitor the file system status (e.g., create, modify, or delete events), monitor operating system events (e.g., Microsoft Windows clipboard operations, etc.), discover and monitor devices added to the remote client system (e.g., plug-and-play devices, USB storage drives, etc.), transmit events periodically to SCP 500, perform actions as directed by SCP 500 (e.g., upload electronic information or destroy electronic information, etc.), receive software updates from SCP 500, or any combination thereof.

Agents 510, 520, and 560 are exemplary agents, and one or more agents may be deployed by CEMS system 100 and communicate with capture system 400 (shown in FIG. 1). For example, agents may be deployed on sources 120, 130 140 and 150 of FIG. 1, as well as sources 160, which are additional sources. Agents may be deployed on desktop systems 402, file systems 406, OLTP applications 410, unified messaging systems 414, IM/PDA systems 418, or applications 422 shown in FIG. 2. The agents, such as agents 510, 520, and 560 of FIGS. 3A and 3B, unobtrusively operate on the target client system (e.g., desktop systems 402, file systems 406, etc.). For example, the agent may be unobtrusive in that, once deployed on a client system, there is no user interface or icon representing the agent visible to a user of the client system. There is also preferably no interaction between deployed agents and users of a client machine. Additionally, agents interact with the client system in the collection of electronic evidence or performing other tasks as instructed by CEMS system 100 so as to minimize the utilization of the system resources (e.g., memory, CPU processing, digital storage, network communications, etc.) on the client machine (i.e., agents operate with low overhead). For example, a threshold level of agent utilization of client system resources may be set such that if the threshold level is exceeded by the activities of the agent, the agent may reduce the use of client system resources for a period of time. Agents may be centrally managed, for example, by SCP 500 of CEMS system 100.

Once the agents (e.g., agents 510, 520, or 560) are deployed and installed on client systems, they communicatively connect via communications network 170 to SCP 500, using the CEMS agent-SCP protocol 530.

Agent-SCP protocol 530 is preferably based on TCP/IP (transfer control protocol/internet protocol) for reliable communication. Agent-SCP protocol 530 is preferably encrypted for secure communication. For example, agent-SCP protocol 530 may use SSL (secure socket layer), TLS (transport layer security), or HTTPS (secure hypertext transfer protocol), or any other suitable secure communications protocol. SCP 500 may be configured to be a server for an agent (e.g., agent 510, 520, 560, etc.) to communicate with. SCP 500 may monitor communications network 170 to determine if agents are attempting to connect to SCP 500. During installation, agents may be, for example, configured with the IP address, port number, public certificate, or other information in order to facilitate connection with SCP 500. Once the agent manager (e.g., agent manager 562 of agent 560) is active, it may initiate communication with SCP 500 and transmit the certificate for authentication. Once SCP 500 validates the authenticity of the certificate, it may open at least one communications channel over communications network 170 for the agent and SCP 500 to communicate.

Upon establishing a transport layer for communications between an agent (e.g., agent 510, 520, 560, etc.) and SCP 500, the agent and SCP 500 may exchange control and data messages via agent-SCP protocol 530 with each other. Agents may initially request that SCP 500 transmit their configurations (e.g., configurations stored on agent configuration and status 550). Next, agents may transmit events to SCP 500 that have been generated by the agent (e.g., where the generated events are stored in event queue 576 for uploading to SCP 500 by event uploader 574 as shown in FIG. 3A). SCP 500 may interpret one or more of the received events, and may convert one or more of the events to commands for the agents. For example, SCP 500 may provide a command to an agent to upload a file that has been recently modified. SCP 500 may also relay commands it receives from CEMS system 100 to an agent (e.g., delete a file on the client machine, etc.).

This communication is preferably initiated by the agent on an interval (e.g., a time interval set by a user or administrator, etc.). If the agent cannot connect to SCP at the end of one interval, it may wait for the next interval. Alternatively, it may reattempt connection one or more times before waiting until the next interval. During a communication interval, agent buffers events (e.g., in event queue 576 shown in FIG. 3B) and removes duplicate events. For example, if an agent determines that the same file is saved more than once over an interval on a client system, an agent may record one event (rather than a series of events for each save operation that occurred during the interval). Thus, an agent may optimize or minimize the number of events sent to SCP 500. If the agent is offline (i.e., cannot connect to SCP 500) for a duration of time, it may buffer the events (e.g., in event queue 576 shown in FIG. 3B). SCP 500 may be configured to determine the frequency that an agent communicates with SCP 500, and may raise an event if the agent does not communicate with SCP 500 for a predefined period of time.

SCP 500 may be configured as a central control point for agents. For example, SCP 500 may authenticate agents (e.g., authenticate agents by using digital certificates), configure agents prior to or after deployment (or both), receive events (e.g., agents may upload events from event queue 576 using event uploader 574 shown in FIG. 3B, etc.) from agents via CEMS agent-SCP protocol 530 over a communications network (e.g., communications network 170), interface with CEMS capture system 400, instruct agents to upload files, or send events or commands to agents (e.g., SCP 500 sends commands 300 or events as shown in FIG. 1 to agents) to perform actions (e.g., commands for particular agents to destroy identified files to comply with an organization's retention policy), or any combination thereof. In some embodiments, SCP 500 may be configured by an administrative console (e.g., administrate console 540 shown in FIG. 3A) that is communicatively coupled to SCP 500 over communications network 170. Administrative console 540 may communicate with and provide instructions to SCP 500, for example, using a web services interface. SCP 500 may store agent configurations on a digital storage device in CEMS system 100 in a central configuration database (e.g., agent configuration and status system 540 illustrated in FIG. 3A).

SCP 500 may configure each agent separately, or may configure groups of agents by using a common configuration for a group. Configuration options, may include, for example, the client machine name (i.e., host name), agent parameters (e.g., agent configuration file 566), agent private key (preferable stored in agent configuration and status 550 associated with SCP 500), grouping of agents (e.g., agents that share the same configurations can be grouped for ease of use), any suitable combination thereof, or any other configuration option. If agents are grouped, SCP 500 may determine a schedule for agents to connect to SCP 500 at particular times or at particular intervals so as to avoid a substantial number of agents connecting to SCP 500 at the same time and overloading SCP 500.

In one embodiment, the CEMS agents are passive and do not perform actions on a client system unless directed by SCP 500. CEMS agents may, for example, crawl the file system on the client system (e.g. user laptop), and monitor the systems for changes to the file system. CEMS agents can also monitor device changes (e.g., addition of plug-and-play devices) to identify any new storage device being attached to the client machine. Thus, agents may detect devices that are connected to the client system that may be sources of electronic evidence (e.g., universal serial bus (USB) thumb-drives, etc.) and to detect the copying of certain files or other electronic information to a removable storage device. The agent activities are controlled by SCP through policies defined by CEMS administrators.

At the direction of CEMS system 100 in the enforcement of organization policy (e.g., organizational policies defined in policies system 265 and enforced by policy enforcer 260 of FIG. 1), agents may be instructed to perform actions such as, destroying files to achieve compliance with the organization's retention policy, prohibiting the copying of files to removable storage, etc. CEMS agents may be configured to monitor network traffic to capture events as defined by the policy instructions sent to the agent by SCP 500. Network traffic may also be logged and retained for storage or analysis by CEMS system 100.

Once CEMS agents (e.g., agents 510, 520, etc.) are deployed and installed on a client system (e.g., desktop systems 402, file system 406, etc.), they are updated with new software substantially automatically by the SCP (e.g., SCP 500). SCP 500 may receive a notification from CEMS system 100 regarding the release of a software update, and, in turn, SCP 500 send commands to agents to update their software accordingly. SCP 500 may track agent activity, as well as the software version information for each agent. Agent information (e.g., agent configurations, software versions, etc.) may be stored in agent configuration and status system 550, illustrated in FIG. 3A, that is communicatively coupled to SCP 500. The software updates for the agents are configured to minimize the amount of system resources of a client system utilized so that agents continue to operate unobtrusively during the update.

FIG. 3B illustrates a more detailed block diagram of the agents shown in FIG. 3A. Although agent 560 is illustrated in detail in FIG. 3B, any agent (e.g., agents 510 or 520, etc.) may have a similar structure. Agent 560 may have agent manager 562, which is configured as the central control point for agent tasks. For example, agent manager 562 may open a connection with SCP 500 using agent-SCP protocol 530 via communications network 170. This may initiate event dispatcher 564 to wait to receive events from SCP 500. Agent manager 562 may also be configured to download agent configuration (e.g., from SCP 500 via agent configuration and status system 550 illustrated in FIG. 3A) and store the agent configuration locally (e.g., on agent 560 at agent configuration file system 566). Agent manager 562 may also be configured to add agent event registration (i.e., register the events in for example, configuration file system 566 that are received from SCP 500 and are to be carried out by agent 560), which may be used by event dispatcher 564. Agent manager 562 may also be configured to control (e.g., start or stop) various agent tasks such as file system crawling (e.g., by controlling file system crawler 568 and storing the information on file catalog 570), monitoring (e.g., controlling monitor 572 to monitor the file system, network activity, plug-and-play devices, etc.), event uploading (e.g., control event uploader 574), or any combination thereof, or any other suitable task. Agent manager 562 may also be configured to configured tasks using definitions in a configuration file stored in configuration file system 566. Agent manager 562 may also be configured to register with event dispatcher 564 for configuration events. For example, agent manager 562 may create a configuration file (e.g., a configuration file located on configuration file system 566) with information provided by SCP 500. Upon reception of a configuration update, agent manager 562 may modify a configuration file on configuration file system 566 and may update agent tasks in the file accordingly. Agent manager 562 may register with event dispatcher 564 for service control events. These events may be sent by SCP 500 to control (e.g., start or stop, etc.) agent tasks (e.g., tasks performed by agent 560).

Agent configuration file system 566 may store one or more agent configuration files. Agent configuration files may be, for example, an XML document of the current agent configuration and its tasks. The configuration file, or the agent configuration file system 566, or any combination thereof may be encrypted, and may also be hidden from other users on the client machine. Agent manager 562 may read the configuration file, and may periodically update the tasks detailed within the file.

Event dispatcher 564 of agent 560 is configured to wait for incoming events from SCP 500, and dispatches the events so that the tasks for agent (as defined by the received event) are registered for the specific event (e.g., registered in the configuration file of configuration file system 566). During the configuration phase, agent manager 562 may read one or more event registrations from the configuration file stored on configuration file system 566, and update event dispatcher 564 with this information. Event dispatcher 564 may be configured to provide interfaces for agent manager 562 to add an event registration.

Event uploader 574 may be configured to provide interfaces for agent manager 564 to add events to the event registrations stored in configuration file system 566. Event uploader 574 may be configured to read events from the event queue manager 576 and send them to SCP 500. Event uploader 574 may upload the events as defined in the configuration file stored in configuration file system 566. SCP 500, through agent manager 562, may configure the frequency of uploading events by event uploader 574. Preferably, events may be handled on a first in, first out (FIFO) basis. Event uploader 574 may be configured to read an event from event queue manager 576 and inform event queue manager 576 upon successful completion of sending the event to SCP 500 via communications network 170.

If the communicative coupling between an agent (e.g., agent 560) and SCP 500 is not operational, event uploader 574 may generate an event for agent manager 562 to indicate the communication has been interrupted or is unavailable. Agent manager 562 may control event uploader 574 to stop the event uploader task and restart it upon successful connection to SCP 500.

Event queue manager 578 is configured to manage event queue 576 for events to be transmitted to SCP 500. Event queue manager 578 may be configured so that events generated by agent tasks are saved in event queue 576. These events in event queue 576 may eventually be uploaded by event uploader 574. Event queue manager 578 may be configured to provide interfaces for tasks to add events and for event uploader 574 to deliver events to SCP 500.

Upon receipt of an event, event queue manager 578 may store it locally for persistence. Event manager 578 may also maintain a small number of events in memory in, for example, a FIFO structure for faster response to event uploader 574. During a restart of event queue manager 578, it may first determine if there are any pending events and cache part of them in memory (e.g., an encrypted portion of client system memory). When an event uploader task becomes active, these events may be transmitted to SCP 500.

SCP 500 may instruct agents (e.g., agents 510, 520, 560, etc.) to carry out various tasks. Tasks received by an agent (e.g., agent 560) from SCP 500 may be handled by event handler 580. For example, SCP 500 may provide event handler 580 of agent 560 with the file path of the file to be deleted. Event handler 580 may handle any other suitable task as directed by SCP 500.

File system crawler 568 of agent 560 may be configured to iterate over the file system residing on the client machine. Alternatively, file system crawler 568 may be instructed to iterate over files except those files listed in an exclude list (e.g., an exclude list provided by SCP 500). Depending on the client machine, file system crawler 568 may, for example, be configured to utilize the Microsoft Windows API (Application Program Interface) to crawl the file system. File system crawler 568 or monitor 572 may, for example, be configured to exclude certain directories, system directories, file extensions, or files, or any combination thereof. File system crawler 568 or monitor 572 may be configured to search for at least one particular type of file (e.g., Microsoft® Word documents, etc.).

Upon crawling the file system, file system crawler 568 may find a file (which is not part of an exclude list) may add an entry in file catalog 570, add an event in event queue 576 to be transmitted to SCP 500, or perform any other suitable action. Events may contain, for example, file metadata such as the name of the file, the file path where the file resides on the client machine, or any other suitable information. Upon completing a crawl of the file system of the client machine, file system crawler 568 may, with the direction of agent manager 562, update the agent configuration file stored in configuration file system 566 with the time of the last file crawl or other suitable information.

Agent manager 562 may initiate a file system crawl of the client machine by directing file system crawler 568 when it is first started on a client machine or at a particular time specified by SCP 500. After an initial crawl of the file system, agent manager 562 may track the file monitoring of monitor 572 and may perform another file system crawl if file monitoring by monitor 572 was interrupted. If the crawler is restarted due to an interrupt, it may check file catalog 570 if the file already exists and what its status is, and accordingly add an event (and catalog entry) for the file.

On subsequent crawls after the first successful crawl of the file system, file system crawler 568 may go through substantially all the files on the client system and determine if the time of the last modification of the file is greater that the last successful crawl time in the agent configuration file stored in configuration file system 566. If it is greater, file system crawler 568 may raise an event to transfer the file and update file catalog 570 with the new information.

File system crawler 568 or monitor 572 may create an event for each new file found on a client machine. Upon creation of an event for a new file found (i.e., a file creation and modification event), the event may be transmitted to SCP 500 by event uploader 574. Upon receiving the event, SCP 500 may send back an event to the agent (e.g., agent 560) to upload the file (e.g., file uploader 582 may upload the file). SCP 500 may transmit the event to upload one or more files. File uploader 582 may be registered to receive events from event dispatcher 564.

Upon receipt of the event, file uploader 582 may change the status of the file in file catalog 570 to “file transfer start” and copy the file to a temporary area (e.g., temporary storage 584). Next, it may transfer the file to SCP 500. In some embodiments, the start transfer watermark value, which is set by SCP 500 and is saved in configuration file of configuration file system 566 is true. The start transfer watermark value may be, for example a combination of the following CPU (central processing unit) load is below about 50%, and network utilization is less than about 25%. The start transfer watermark value may be comprised of other suitable percentages of CPU load and network utilization, or other factors of the client machine. For example, on a client machine with the Microsoft Windows operating system, these load values may be obtained from the Task Manager APIs.

If file uploader 582 if interrupted during transfer of a file to SCP 500, it may either restart the transfer of the file or, by maintaining a marker for how many bytes have been transferred, it may restart a file transfer starting at the marker point. Periodically, file uploader 582 may check, for example, the CPU and network utilization values of the client system and may decide to stop the transfer it the load usage (CPU and network) is meeting or exceeding a stop transfer watermark value (which may be set by SCP 500). The stop transfer watermark value may be, for example, a CPU load value above about 80%, and a network utilization value of above about 75%.

File catalog 570 of agent 560 in FIG. 3B may be maintained for files of a client machine. File catalog 570 may be maintained in a binary format which will not be easily readable by user of the client machine. File catalog 570 may be configured such that file system crawler 568 tracks which files are transmitted to SCP 500 and enable file system crawler 568 to send the files changed since the last file system crawl to SCP 500. File catalog 570 may also help file system monitor to not raise duplicate events when both crawler and monitor processes are running simultaneously. File catalog 570 preferably may be maintained as a hash table, with a key (e.g., full file name, file path, signature and relative path, etc.), file last upload time, status (e.g., event sent, file transfer start, file transfer finish, etc.), or other suitable information.

When file system crawler 568 is initially executed on a client system, it adds entries to file catalog 570, sets the status to “event sent” in file catalog 570, and transmits the events to SCP 500. When SCP 500 requests to download a file, file uploader 582 of agent 560 may update the status in file catalog 570 to “file transfer start” before copying the file temporary storage 584 and to “file transfer finish” after a successful upload operation. File uploader 582 may also update the file last upload time in file catalog 570 before copying the file to temporary storage 584. If the copy operation fails, file uploader 582 may reset the status values for the file in file catalog 570 to the previous state or a default state. Upon deletion or destruction of a file, file catalog 570 is accordingly updated.

Monitor 572 may be configured to monitor activity on a client machine. Such activities may include, but are not limited to file systems monitoring, network monitoring, plug-and-play device monitoring, or other suitable activities.

After a successful crawl of the file system on the client machine, monitor 572 may monitor the file system in order to determine whether a user has, for example, deleted a file, added a new file (e.g., creating a file, saving a file, copying files from another location, saving a file attached in an email, etc.), or moved a file to a different location (i.e., the file contents have not changed, but the metadata associated with a file has changed).

Monitor 572 may, for example, monitor the file system by utilizing a filter driver which may procure the file system events from the operating system of the client machine. The filter driver may be, for example, implemented in the kernel mode of the operating system and may forward the file delete, file move, file save and file close events to monitor 572.

Upon receipt of a file save event, monitor 572 may check the status of this file in file catalog 570, and if the status is “event sent,” it may drop the event. Otherwise, it may modify the status to “event sent” and add the event to event queue 576 (where the event may be stored until it is sent to SCP 500 the next time the agent connects to SCP 500). SCP 500 may request that agents send events periodically.

Monitor 572 may also monitor plug-and-play devices, and notify SCP 500 if devices are discovered on the client machine. In addition, monitor 572 may monitor network traffic events of the client system, and provide logs or network activity information to SCP 500.

Turning to FIG. 4, once CEMS capture system 400 of CEMS system 100 obtains an item of electronic evidence (e.g., file pair 180 illustrated in FIGS. 1 and 4), it is placed in CEMS drop zone 200 and an entry is added to queue 220, as shown is FIG. 4. IOA 230 is configured to monitor queue 230 using drop zone monitor 210. IOA 230 processes the entries of queue 220 as described below, and marks them with an identifier when processing has been completed. CEMS system 100 is configurable to scale to multiple IOA software instances.

As shown in FIG. 4, IOA 230 analyzes the items of electronic evidence (e.g., file pairs) that have been placed in queue 220, and processes the file pair by separating the blob from the associated metadata. IOA 230 adds an entry for the captured evidence (i.e., blob and associated metadata) in CEMS repository 240. Preferably, blobs are stored in encrypted file system 242, and the blob's associated metadata is stored in metadata database 244. CEMS repository 240 may preferably be comprised of encrypted file system 242 and metadata database 244. Several types of metadata may be associated with a blob, and stored in metadata database 244. For example, metadata may be classified as system-defined metadata, or site-specific metadata, or any combination thereof. In this exemplary metadata classification, system-defined metadata may be further subdivided into extrinsic and intrinsic metadata. Extrinsic metadata may be obtained from the file system metadata for documents (i.e., blobs) on remote client machines (e.g., file paths, “email to” fields, etc.). CEMS capture system 400 may also store appropriate metadata associated with the captured electronic evidence and store it in metadata database 244, such as the time of capture, the identification of the source system, logged-in user information (e.g., information related to the user who is logged-in to an organization's network), files copied from an external storage device, or other related information known by the capture system but not normally embedded within the electronic evidence itself. CEMS capture system 400 stores the extrinsic metadata in metadata database 244. Intrinsic metadata, another type of system-defined metadata, may be metadata that is contained in the blob (e.g., properties of a Microsoft Word document, etc.). In contrast to system-defined metadata, site-specific or user-defined metadata may be, for example, any metadata classifications that are meaningful to an organization. For example, an organization may have product information which may be tagged with site-specific metadata so as to classify the product information as having restricted user access.

IOA 230 extracts the metadata (e.g., extrinsic and intrinsic metadata) from file pair 180 in drop zone 200. If the object contains other embedded objects (e.g., a Microsoft® PowerPoint presentation object with a Microsoft® Excel spreadsheet document as an embedded object in the presentation, etc.), IOA 230 may extract the embedded objects first. IOA 230 may also extract text (e.g., unformatted text, etc.) from an object or at least one embedded object and direct it to an indexer within IOA 230 for full text indexing, lexical analysis, classification, social network analysis, or any other suitable analysis.

IOA 230 may be configured to be scalable for analyzing electronic evidence (e.g., documents). In order to apply and enforce organizational policies, IOA 230 may classify the electronic evidence (blob) based on its content, and update the site-specific metadata associated with the document. The classification may occur with the blob stored in encrypted file system 242, and the associated updated metadata may be stored in metadata database 244. IOA 230 may also be configured extract social network information from the document, including, but not limited to the name of the creator of the document, viewers of the document, updaters of the document, email recipients of the document, proxies used in the documents, or any other suitable information. IOA 230 may be configured to update the document metadata (e.g., metadata stored in metadata database 244) appropriately after extracting the social information from the electronic evidence. IOA 230 may also be configured to perform lexical analysis of the document, create lexical thumbprints or tokens for the document, which may increase a user's ability to quickly and accurately search for the electronic evidence with CEMS system 100.

CEMS system 100 (shown in FIG. 1) may be configured with centralized events system 600 illustrated in FIG. 5 that logs events. These logged events may be organized by events system 600 into categories (e.g., info, warning, error, audit, or any other suitable category, etc.). As shown in FIG. 5, as event monitor 604 receives an event (e.g., event 602), event monitor 604 logs event 602 and works with event dispatcher 606 to send event 602 to an event handler (e.g., event handler 608). Although event handler 608 is illustrated in FIG. 5, there may be many event handlers similar to event handler 608, each handling different events, different portions of a related event, or any suitable combination thereof. The dispatching by event dispatcher 606 may be based, for example, on event handlers (e.g., event handler 608 or event handler 290 of FIG. 1) that are registered (e.g., by event registration system 610 and stored in event registration table 612) with the event manager for particular event types.

As events are dispatched (e.g., by events dispatcher 606), event handlers (e.g., event handler 608) may perform actions as defined by policies which have been defined in CEMS system 100. CEMS may be configured such that multiple event handlers register for the same event. The CEMS event manager 620 of events system 600 may log the events (e.g., event 602) in events tables 630. Preferably, events tables 630 may be comprised of non-encrypted events tables 640 and encrypted events tables 650. Non-encrypted events table 640 is a read-only copy for users to browse, search, analyze, produce, or perform any other suitable action on. CEMS system 100 does not allow modification or deletion of events in event tables 630 after they are logged. Preferably, only event manager 620 may write to events tables 630. Writing by events manager 620 into events tables 630 may preferably be performed by using database constructs to monitor changes to events tables 630 (e.g., non-encrypted events tables 640 and encrypted events tables 650). Yet, a system-level attacker could attempt to circumvent the CEMS system security to modify the events in the tables. Encrypted events tables 650 may be used to verify if the non-encrypted table has been modified or tampered with.

As described above in connection with FIGS. 1-5, CEMS system 100 may be an evidence management system configured to have agents deployed on client systems that are sources of potential evidence. For example, source systems may include, but are not limited to laptop personal computers, desktop personal computers, personal digital assistants, cell phones, wireless portable email devices, shared file servers, network devices, proxy servers, any combination thereof, or any other suitable devices. Upon receipt of events from SCP 500, one or more agents (e.g., agents 510, 520, 560 etc.) capture at least a portion of the files in the file system, monitors changes to the file system, monitors removable storage devices connected to the client system, monitors instant message traffic, monitors emails, or monitors network traffic, or any suitable combination thereof. CEMS system 100 may be configured to control the remote agents via SCP 500 and invoke the agents to carry out particular tasks by sending events via agent-SCP protocol 530. Thus, agent monitoring of a client system is definable and dynamic, and is useful for compliance with organizational policies (e.g., organizational policies defined in policies system 265). One or more agents may be, for example, deployed on client systems (e.g., laptops, file servers, etc.) using typical software deployment and distribution methods which are commonly used by information technology (“IT”) departments. After one or more agents are deployed, the agents (e.g., agents 510, 520, 560, etc.) communicatively connect to SCP 500 of CEMS system 100 via communications network 170 using agent-SCP protocol 530.

SCP 500 is configured to direct activities of the remotely deployed agents on client systems. Accordingly, agents may be non-active until receipt of instructions (e.g., events) by SCP 500. Preferably, SCP 500 is configured to utilize secure communications via agent-SCP protocol 530 to provide instructions to at least one remote agent. Based on organization policies (e.g., polices defined in policies system 265), at least one remote agent may be configured to capture data (e.g., files, changes to the file system, network traffic, etc.) and synchronize with SCP 500 at predefined times or times determined by an administrator of CEMS system 100. As instructed by events sent from SCP 500, agents may copy or read entire file systems (e.g., using file systems crawler 568), monitor file system activity (e.g., using monitor 572), monitor communications network activity, report on activities of the host system, or perform tasks (e.g., copy files, destroy files, etc.). Agents may also receive commands from SCP 500 to, for example, harden the client system. A hardened client system, for example, disables a user of the client machine from copying documents outside of the organization's network. SCP 500 may be configured to control agents individually or in groups, whereby an agent takes no action on a client system until an event is received from SCP 500.

Pursuant to events or commands (i.e., instructions) transmitted by SCP 500 that are generated by CEMS system 100, the one or more deployed agents may communicatively connect to SCP 500 over a communications network periodically or at predefined time intervals and may send updates of activities of the host system recorded by the agent to SCP 500. Depending on the type, class, location, department, or user of the client system on which the agent is deployed, SCP 500 may configure the agent to the specific capturing, monitoring, or other needs associated with the specific class of user. For example, SCP 500 may direct an agent to communicatively connect with SCP 500 every hour. Between the reporting intervals, the agent may be instructed to buffer a portion of or substantially all of the activity of the host system and de-duplicate similar events, identical files, or other information. For example, when a user is logged on the client machine and saves a document ten times within the period, the agent may preferably capture this as a single event. This minimizes the amount of events to be queued in the event queue of an agent (e.g., event queue 576), thus also minimizing the number of events to be uploaded to SCP 500 (e.g., using event loader 574). This, in turn, minimizes the information uploads to SCP 500. In addition, the de-duplication further minimizes the system load on the client machine in which the agent is deployed on, and also minimizes the number of events to be processed by CEMS system 100 that are received from the agents (in this example, a single event is processed, rather than ten events). Depending of the policy definitions, SCP 500 may be configured to upload the electronic information or may alternatively be configured not to upload the electronic information if the electronic information is already captured in CEMS system 100, thus minimizing the use of client and network resources.

Upon receipt of the events by SCP 500 from, for example, events system 600 of CEMS system 100, specific events (e.g., policy enforcement events) may be transmitted to agents. Agents receive the events and convert them into agent tasks. SCP 500 may be configured to control which events get sent to a particular agent for conversion into agent tasks, as well as when the events are sent in time. A CEMS administrator may preferably control the customization of the SCP system to control, for example, when agents connect with the SCP or the priority of events to be transmitted to agents. The SCP is scalable to manage one or more agents, where the number of agents may be increased and where activities of particularly identified agents may be giving specific priority as desired.

Some CEMS agents may be deployed on client systems that may have periodic or infrequent connection to a communications network (e.g., communications network 170). For example, an agent may be deployed on a laptop computer which may be unconnected to an organization's network for extended periods of time. In this example, an agent that has been provided with instructions to gather information may buffer (e.g., in file catalog 570, event queue 576, etc.) at least a portion of or substantially all of the changes made to files, the file system, or any other aspects of the client system and attempt to connect to SCP 500 periodically. Once a connection is made, agents may upload the change events (e.g., using event uploader 574) and wait to receive additional events from SCP 500. CEMS administrators may set parameters for when agents attempt to connect to SCP 500. These parameters can be specific for individual agents or for groups of agents.

The detailed description set forth above in connection with the appended drawings is intended as a description of various embodiments and is not intended to represent the only embodiments which may be practiced. The detailed description includes specific details for the purpose of providing a thorough understanding of the embodiments. However, it will be apparent to those skilled in the art that the embodiments may be practiced without these specific details. In some instances, well known structures and components are shown in block diagram form in order to avoid obscuring the concepts of the exemplary embodiments.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for capturing electronic evidence using one or more agents and at least one service control point, comprising:
deploying the one or more agents to one or more sources of electronic evidence;
transmitting one or more events from the at least one service control point to the one or more agents, wherein the one or more agents do not perform any tasks unless events are received; and
upon receipt of the one or more events by the one or more agents, performing at least one task on the one or more sources of electronic evidence.

2. The method of claim 1, wherein transmitting the one or more events from the at least one service control point to the one or more agents comprises communicating using an encrypted agent to service control point protocol.

3. The method of claim 1, wherein the performing the at least one task comprises the one or more agents capturing electronic evidence from the one or more sources.

4. The method of claim 1, wherein the performing the at least one task comprises the one or more agents enforcing policies as transmitted by the at least one service control point.

5. The method of claim 1, wherein the performing the at least one task comprises the one or more agents monitoring the one or more sources.

6. The method of claim 1, further comprising one or more agents transmitting information related to the at least one task from the one or more sources to the at least one service control point.

7. A system for capturing electronic evidence using one or more agents and at least one service control point, comprising:
means for deploying the one or more agents to one or more sources of electronic evidence;
means for transmitting one or more events from the at least one service control point to the one or more agents, wherein the one or more agents do not perform any tasks unless events are received; and
upon receipt of the one or more events by the one or more agents, means for performing at least one task on the one or more sources of electronic evidence.

8. The system of claim 7, wherein the means for transmitting the one or more events from the at least one service control point to the one or more agents comprises means for communicating using an encrypted agent to service control point protocol.

9. The system of claim 7, wherein the means for performing the at least one task comprises means for capturing electronic evidence with the one or more agents from the one or more sources.

10. The system of claim 7, wherein the means for performing the at least one task comprises means for the one or more agents enforcing policies as transmitted by the at least one service control point.

11. The system of claim 7, wherein the means for performing the at least one task comprises means for the one or more agents monitoring the one or more sources.

12. The system of claim 7, further comprising one or more agents transmitting information related to the at least one task from the one or more sources to the at least one service control point.

13. A computer readable medium comprising software that, when executed by a computer, causes an electronic evidence management system to perform a method for capturing electronic evidence using one or more agents and at least one service control point, the method comprising:
deploying the one or more agents to one or more sources of electronic evidence;
transmitting one or more events from the at least one service control point to the one or more agents, wherein the one or more agents do not perform any tasks unless events are received; and
upon receipt of the one or more events by the one or more agents, performing at least one task on the one or more sources of electronic evidence.

14. The medium of claim 13, wherein transmitting the one or more events from the at least one service control point to the one or more agents comprises communicating using an encrypted agent to service control point protocol.

15. The medium of claim 13, wherein the performing the at least one task comprises the one or more agents capturing electronic evidence from the one or more sources.

16. The medium of claim 13, wherein the performing the at least one task comprises the one or more agents enforcing policies as transmitted by the at least one service control point.

17. The medium of claim 13, wherein the performing the at least one task comprises the one or more agents monitoring the one or more sources.

18. The medium of claim 13, further comprising one or more agents transmitting information related to the at least one task from the one or more sources to the at least one service control point.
